(19) United States
(12) Patent Application Publication
(10) Pub. No.: US 2025/0118517 A1
(43) Pub. Date: Apr. 10, 2025

(54) HANDLE LOCK DEVICE FOR A CIRCUIT BREAKER

(71) Applicant: FUJI ELECTRIC FA COMPONENTS & SYSTEMS CO., LTD., Konosu-shi (JP)

(72) Inventors: Hiroto YAMADA, Konosu-shi (JP); Hiroshi MORIAI, Ohtawara-shi (JP); Takayuki TAKAHASHI, Konosu-shi (JP)

(73) Assignee: FUJI ELECTRIC FA COMPONENTS & SYSTEMS CO., LTD., Konosu-shi (JP)

(21) Appl. No.: 18/894,257

(22) Filed: Sep. 24, 2024

(30) Foreign Application Priority Data
Oct. 6, 2023 (JP) 2023-174506

(51) Int. Cl. H01H 71/52

(52) U.S. Cl. CPC H01H 71/521

(57) ABSTRACT

There is provided a circuit breaker handle lock device capable of enhancing work safety. By inserting slide pins through a first slotted hole of a locking plate and a second slotted hole of a lock plate and connecting the slide pins to a slide part, a handle catch and the lock plate are arranged to be slidable in the movement direction of a knob part with respect to the locking plate. A second lock hole of the slide part and a first lock hole of the locking plate communicate with each other at the OFF position of the knob part, and the locking plate is blocked with the second lock hole at the ON position of the knob part. The lock plate moves in the movement direction of the knob part while blocking the first slotted hole of the locking plate.

### TECHNICAL FIELD

The present invention relates to a handle lock device applied as external accessory device of circuit breakers such as molded-case circuit-breakers, and earth leakage breakers.

### BACKGROUND ART

To prevent an opening and closing operation handle of a circuit breaker attached to a panel board from being erroneously switched from the OFF position (position where the main circuit contact is opened) to the ON position (position where the main circuit contact is closed), there is an increasing demand for a handle lock device locking a knob part of a locker-type opening and closing operation handle at the OFF position.

Devices are known as conventional handle lock devices in which a lock member restrains a knob part of an opening and closing operation handle at the OFF position for locking by hooking a padlock or a hasp through a lock hole (e.g., Patent Document 1).

### CITATION LIST

### Patent Literature

Patent Document 1: JP 2015-43264 A

### SUMMARY OF INVENTION

### Technical Problem

The conventional handle lock devices have a risk of erroneous mounting of the padlock or the hasp caused by hooking of the padlock or the hasp through a hole, if any, present in a place other than the lock hole of the padlock or the hasp, even when the knob part of the opening and closing operation handle is located at the ON position, which poses a problem of work safety.

Further, when a small padlock is attached to lock the knob part at the OFF position, the knob part sometimes moves to a position where the position of the knob part is switched to the ON position, which also poses a problem of work safety.

Thus, it is an object of the present invention to provide a circuit breaker handle lock device capable of enhancing the work safety.

### Solution to Problem

To achieve the above-described object, provided is a handle lock device for locking a knob part of a locker-type opening and closing operation handle projecting from a surface of the circuit breaker at an OFF position. The handle lock device comprises: a lock frame having an opening part and configured to be mounted to the surface of the circuit breaker, the lock frame having a locking plate raised from an edge part forming the opening part, the locking plate having a first lock hole for receiving a shackle of a locking member and a first slotted hole; a handle catch configured to include a catch part for holding the knob part and a slide part arranged to face the locking plate, the slide part having a second lock hole corresponding to the first lock hole; a lock plate arranged between the locking plate and the slide part, the lock plate having a second slotted hole arranged to correspond to the first slotted hole, the second slotted hole having a longitudinal dimension shorter than that of the first slotted hole and a short-length dimension same as that of first slotted hole; and a slide pin configured to be inserted through the first slotted hole of the locking plate and the second slotted hole of the lock plate and to slidably connect the slide part relative to the locking plate. The second lock hole of the slide portion is, at the OFF position of the knob part, in communication with the first lock hole of the locking plate, whereas the second lock hole of the slide part is, at an ON position of the knob part, blocked with a part of the locking plate. The lock plate moves while locking at least a part of the first slotted hole in a manner that the slide pin comes into contact with the second slotted hole in accordance with sliding motion of the slide part.

### Advantageous Effects of Invention

The circuit breaker handle lock device according to the present invention can enhance the work safety of the circuit breaker.

### BRIEF DESCRIPTION OF DRAWINGS

FIG. 1 is a perspective view illustrating a state in which, when a handle lock device of a first embodiment is mounted to a circuit breaker and a knob part of a locker-type opening and closing operation handle is located at the OFF position, a first lock hole of a locking plate and a second lock hole of a handle catch communicate with each other, allowing the locking with a padlock or a hasp.

FIGS. 2A and 2B are perspective views illustrating the configuration of the handle lock device of the first embodiment.

FIGS. 3A and 3B illustrate a state in which, when the handle catch moves to the OFF position of the knob part or the ON position of the knob part, a lock plate blocks a place through which a shackle of the padlock or the hasp can pass in the handle lock device of the first embodiment.

FIG. 4 is a view illustrating a state in which, when the knob part of the circuit breaker is located at the OFF position, the first lock hole of the locking plate and the second lock hole of the handle catch of the handle lock device of the first embodiment communicate with each other, and the shackle of the padlock is hooked for locking.

FIG. 5 is a perspective view illustrating a state in which the knob part of the circuit breaker moves to the ON position, and the first lock hole of the locking plate and the second lock hole of the handle catch of the handle lock device of the first embodiment do not communicate with each other, not allowing the hooking of the shackle of the padlock.

FIG. 6 is a view illustrating a state in which, when the first lock hole of the locking plate and the second lock hole of the handle catch of the handle lock device of the first embodiment do not communicate with each other, the lock plate blocks a place through which the shackle of the padlock can pass.

FIGS. 7A and 7B are perspective views illustrating the configuration of a handle lock device of a second embodiment.

FIG. 8 is a view illustrating the configuration of the handle lock device of the second embodiment.

FIG. 9 is a view illustrating the shape of a lock plate constituting the handle lock device of the second embodiment.

FIG. 10 is a perspective view illustrating a state in which, when a knob part of a circuit breaker is located at the OFF position, a first lock hole of a locking plate and a second lock hole of a handle catch of the handle lock device of the second embodiment communicate with each other.

FIG. 11 is a view illustrating a state in which, when the first lock hole of the locking plate and the second lock hole of the handle catch of the handle lock device of the second embodiment communicate with each other, a shackle of a padlock is hooked for locking.

FIG. 12 is a perspective view illustrating a state in which the knob part of the circuit breaker moves to the ON position, and the first lock hole of the locking plate and the second lock hole of the handle catch of the handle lock device of the second embodiment do not communicate with each other, not allowing the hooking of the shackle of the padlock.

FIG. 13 is an enlarged view of a principal part illustrating a state in which the first lock hole of the locking plate and the second lock hole of the handle catch of the handle lock device of the second embodiment do not communicate with each other.

FIG. 14 is a view illustrating the structure in which, when a small padlock is attached to lock the OFF position of the knob part, the handle catch holding the knob part restricts the knob part from moving to a position where the position is switched to the ON position in the handle lock device of the second embodiment.

### DESCRIPTION OF EMBODIMENTS

Embodiments according to the present invention will be described below with reference to the drawings. In the drawings, the same or similar reference numerals are attached to the same or similar parts. It should be noted that the drawings are schematic, and the relationship between the thickness and the plane dimension, the thickness ratio of each layer, and the like are different from the actual relationship, ratio, and the like. Therefore, the specific thickness and dimension should be determined in consideration of the following description. It is a matter of course that the drawings include portions different in mutual dimensional relationships and ratios.

The embodiments described below exemplify devices or methods for embodying the technical idea of the present invention. The technical idea of the present invention does not specify the materials, shapes, structures, arrangement, and the like of constituent components to the materials, shapes, structures, arrangement, and the like described below. The technical idea of the present invention can be variously altered within the technical scope defined by the claims.

### First Embodiment

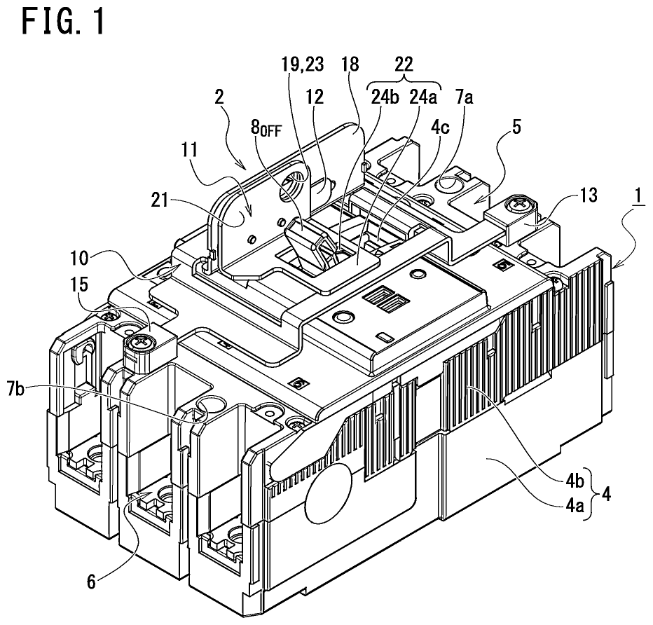

FIGS. 1 to 6 illustrate a handle lock device 2 of a first embodiment mounted to a circuit breaker 1.

As illustrated in FIG. 1, the circuit breaker 1 includes a main body case 4 composed of a box-shaped base 4a and a cover 4b, in which a three-pole power supply-side terminal part 5 and a load-side terminal part 6 are formed in both side parts of the main body case 4.

Fixing screws (not illustrated) are inserted through screw holes 7a and 7b provided between the poles of the power supply-side terminal part 5 and the load-side terminal part 6, respectively, to be screwed into a panel board, so that the circuit breaker 1 is arranged in the panel board. In the upper surface of the cover 4b of the main body case 4, an opening part 4c is formed. A knob part 8 of a locker-type handle operating the toggle link mechanism (opening and closing mechanism) arranged inside the main body case 4 projects upward from the opening part 4c. Herein, the reference numeral 8_{OFF} designates a position where the knob part 8 is set to OFF such that the main circuit contact of the circuit breaker 1 is opened (hereinafter referred to as an OFF position 8_{OFF}). The reference numeral 8_{ON} described later designates a position where the knob part 8 is set to the ON position such that the main circuit contact is closed (hereinafter referred to as an ON position 8_{ON}).

On the right side in FIG. 1 with respect to the screw hole 7a formed in the cover 4b, a power supply-side engagement part is formed, with which a power supply-side mounting screw 14 described later of the handle lock device 2 is engaged. On the left side in FIG. 1 with respect to the screw hole 7b, a load-side engagement part is formed, with which a load-side mounting screw 16 described later of the handle lock device 2 is engaged. The power supply-side engagement part and the load-side engagement part are blind holes in which female threads formed thereinside are blocked with plastic lids.

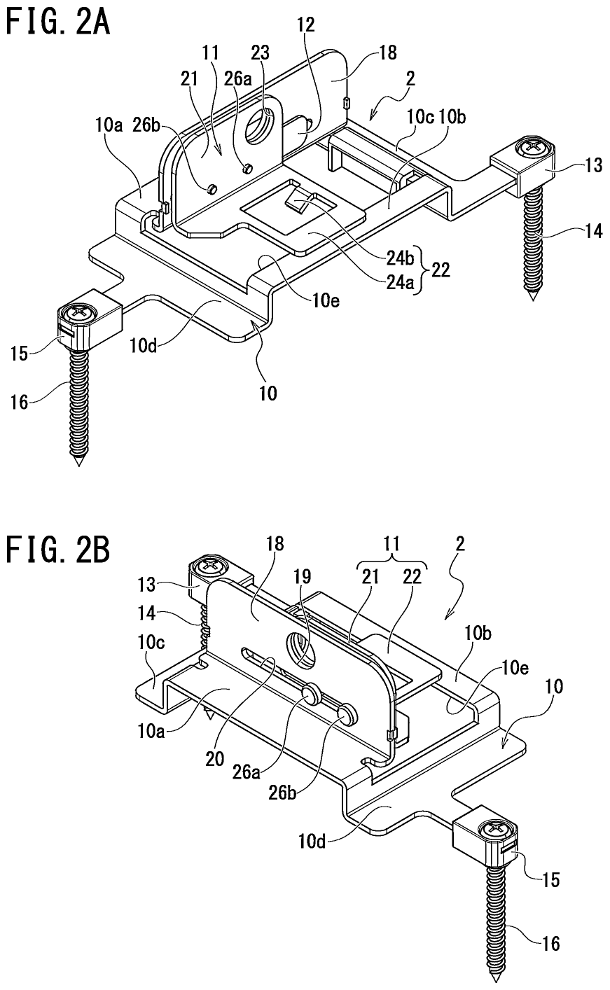

As illustrated in FIG. 2A, the handle lock device 2 includes a lock frame 10, a handle catch 11, and a lock plate 12, which are formed of metal plate materials.

The lock frame 10 includes a pair of long first frames 10a and 10b extending parallel to each other and a pair of second frames 10c and 10d connected at both longitudinal end parts of the pair of first frames 10a and 10b and extending parallel to each other. A rectangular opening part 10e surrounded by the pair of first frames 10a and 10b and the pair of second frames 10c and 10d is provided. The second frame 10c side, which is one of the pair of second frames 10c and 10d, of the lock frame 10 is provided with a power supply-side connection part 13 having a through hole and a power supply-side mounting screw 14 inserted through the through hole by the engagement of a head part with the power supply-side connection 13. The second frame 10d side of the lock frame 10 is provided with a load-side connection part 15 having a through hole and a load-side mounting screw 16 inserted through the through hole by the engagement of a head part with the load-side connection part 15.

As illustrated in FIG. 2B, a locking plate 18 is continuously raised from an edge part on the opening part 10e side on the first frame 10a, which is one of the pair of first frames 10a and 10b, of the lock frame 10. A first lock hole 19 is formed in the longitudinal center of the locking plate 18, and a first slotted hole 20 is formed below the first lock hole 19 along the direction in which the first frame 10a, which is one of the pair of first frames 10a and 10b, extends.

As illustrated in FIG. 2A, the handle catch 11 is a member including a slide part 21 and a catch part 22 formed by bending a metal flat plate into an L-shape to be orthogonal to each other. In the slide part 21, a second lock hole 23 is formed which has the same hole shape as that of the first lock hole 19 of the locking plate 18.

The catch part 22 includes a hole part 24a surrounding the periphery of the knob part 8 and an engagement projection 24b projecting from an edge part of the hole 24a and engaged with a part of the knob part 8.

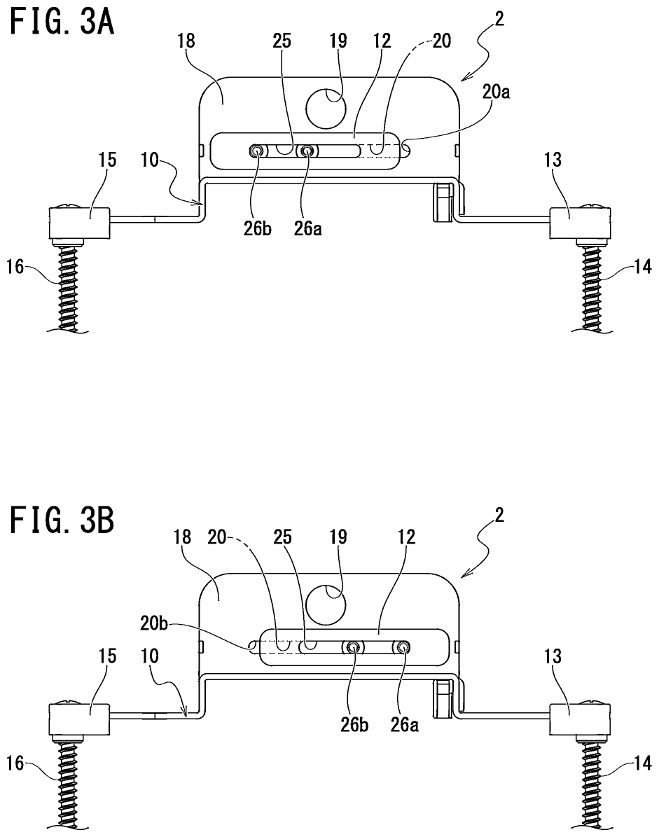

As illustrated in FIG. 3A, the lock plate 12 is a long metal plate and has a second slotted hole 25 having a longitudinal dimension shorter than that of the first slotted hole 20 of the locking plate 18 and having the same short-length dimension as that of the first slotted hole 20. The lock plate 12 is arranged between the locking plate 18 and the slide part 21 with the second slotted hole 25 opposed to the first slotted hole 20 of the locking plate 18. As illustrated in FIG. 2B, two slide pins 26a and 26b are inserted through the first slotted hole 20 and the second slotted hole 26 from the locking plate 18 side. As illustrated in FIG. 2B, head parts of the two slide pins 26a, 26b are engaged with the opening peripheral edge of the first slotted hole 20, and tip parts of the two slide pins 26a, 26b penetrate the slide part 21 and are crimped and fixed to the slide part 21. Thus, the lock plate 12 is arranged to be slidable with respect to the locking plate 18 via the two slide pins 26a and 26b.

FIGS. 3A and 3B illustrate the moving position of the lock plate 12 when the two slide pins 26a, 26b move to the left side and the right side of the figures together with the movement of the slide part 21. When the lock plate 12 moves to the left side as illustrated in FIG. 3A, an end part of the first slotted hole 20 of the locking plate 18 is opened as a hole part 20a in a right-side end part of the lock plate 12. This hole part 20a is a small opening part through which a shackle of a locking member such as a padlock or a hasp cannot pass. When the lock plate 12 moves to the right side as illustrated in FIG. 3B, an end part of the first slotted hole 20 of the locking plate 18 is opened as a hole part 20b in a left-side end part of the lock plate 12. This hole part 20b is also a small opening part through which a shackle of a padlock or a hasp cannot pass.

The handle lock device 2 having the above-described configuration is mounted to the circuit breaker 1 by inserting the knob part 8 into the hole part 24a of the catch part 22, screwing the power supply-side mounting screw 14 of the power supply-side connection part 13 into the power supply-side engagement part of the circuit breaker 1 arranged in the board of the panel board, and screwing the load-side mounting screw 16 of the load-side connection part 15 into the load-side engagement part of the circuit breaker 1 as illustrated in FIG. 1.

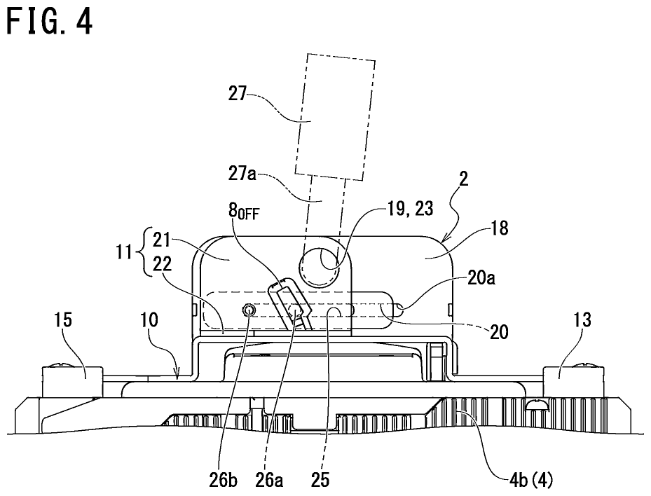

FIGS. 1 and 4 illustrate the arrangement of the handle lock device 2 when the knob part 8 of the circuit breaker 1 is set to the OFF position 8_{OFF}. As illustrated in the figures, the knob part 8 at the OFF position 8_{OFF} is inserted into the hole part 24a, and the knob part 8 at the OFF position 8_{OFF} and the catch part 22 of the handle catch 11 are located on the left side in FIG. 1 at the OFF position. At this time, the first lock hole 19 of the locking plate 18 and the second lock hole 23 of the slide part 21 communicate with each other, allowing the hooking of a padlock 27 by the insertion of a shackle 27a through the first lock hole 19 and the second lock hole 23. As illustrated in FIG. 4, the lock plate 12 blocks most of the first slotted hole 20 of the locking plate 18, and a part of the first slotted hole 20 is opened as the hole part 20a on the right-side end part side of the lock plate 12, but the hole part 20a is so small that the shackle of the padlock or the hasp cannot pass through the hole part 20a as described above.

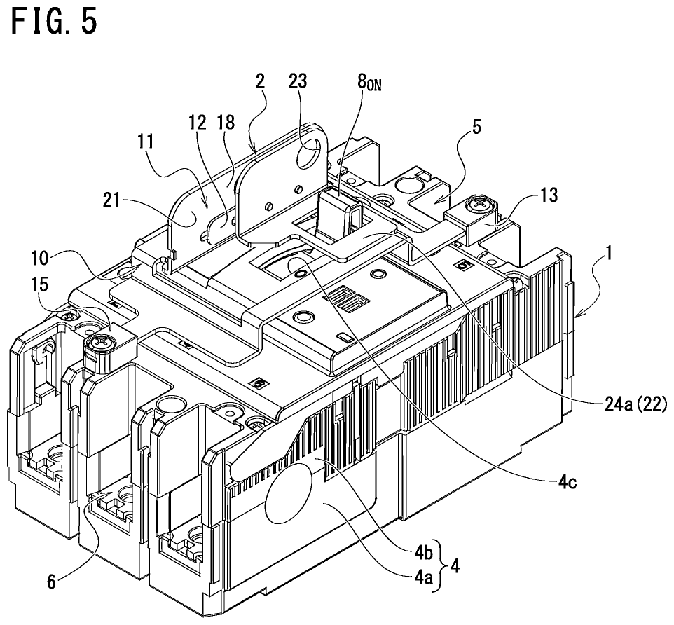

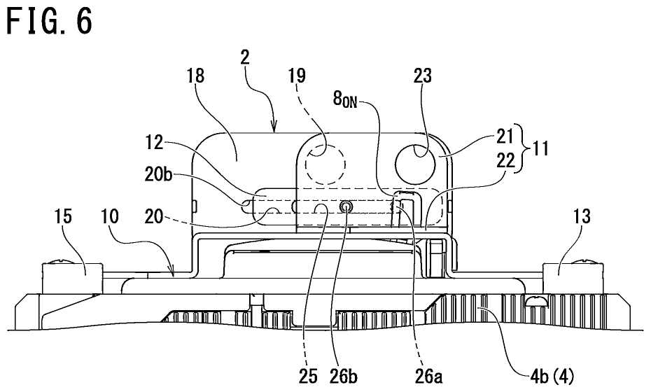

FIGS. 5 and 6 illustrate the arrangement of the handle lock device 2 when the knob part 8 of the circuit breaker 1 is set to the ON position 8_{ON}.

Due to the ON position 8_{ON} of the knob part 8, when the catch part 22 of the handle catch 11 moves to the right side in FIG. 6, the first lock hole 19 of the locking plate 18 and the second lock hole 23 of the slide part 21 do not communicate with each other, not allowing the locking of the padlock. As illustrated in FIG. 6, the lock plate 12 blocks most of the first slotted hole 20, and a part of the first slotted hole 20 is opened as the hole part 20b on the left-side end part side of the lock plate 12. However, the hole part 20b is so small that the shackle of the padlock or the hasp cannot pass through the hole part 20b as described above.

Therefore, the handle lock device 2 of this embodiment can enhance the work safety because the first lock hole 19 of the locking plate 18 and the second lock hole 23 of the slide part 21 communicate with each other only when the knob part 8 of the circuit breaker 1 moves to the OFF position 8_{OFF}, allowing the hooking of the shackle 27a of the padlock 27 for locking, and a hole part (e.g., first slotted hole 20 of the locking plate 18), which is likely to cause erroneous mounting of the shackle of the padlock, is blocked with the lock plate 12.

This embodiment describes the embodiment in which the shackle 27a of the padlock 27 is hooked through the first lock hole 19 of the locking plate 18 and the second lock hole 23 of the slide part 21 communicating with each other for locking. However, even when a hasp is hooked through the first lock hole 19 and the second lock hole 23 communicating with each other for locking, the hole part (e.g., first slotted hole 20 of the locking plate 18), which is likely to cause erroneous mounting of the hasp, is blocked with the lock plate 12, making it possible to enhance the work safety.

### Second Embodiment

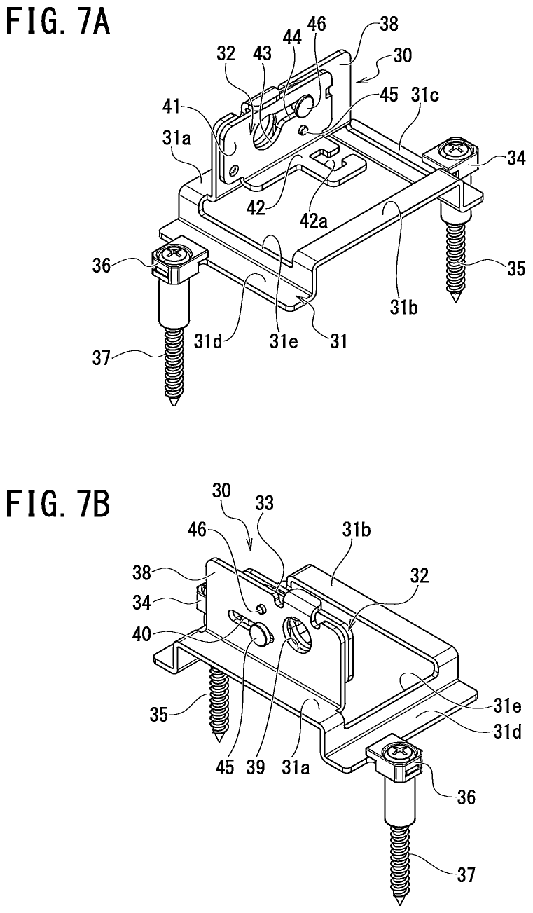

Next, FIGS. 7 to 14 illustrate the structure of a handle lock device 30 of a second embodiment mounted to the circuit breaker 1.

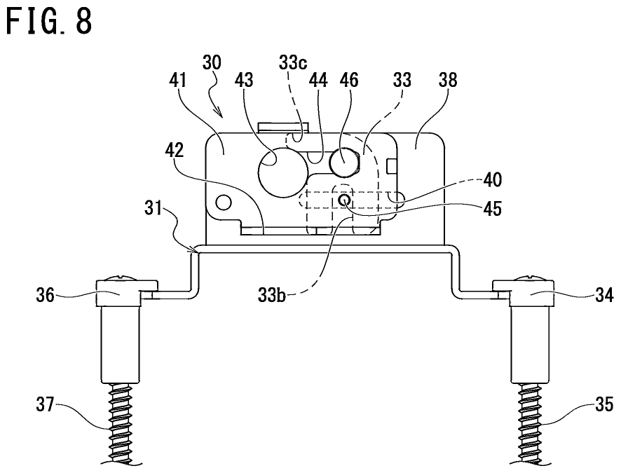

As illustrated in FIGS. 7A, 7B, and 8, the handle lock device 30 includes a lock frame 31, a handle catch 32, and a lock plate 33, which are formed of metal plate materials.

The lock frame 31 includes a pair of first frames 31a, 31b and a pair of second frames 31c and 31d connected at both longitudinal end parts of the pair of first frames 31a and 31b and extending parallel to each other, and is provided with a rectangular opening part 31e surrounded by the pair of first frames 31a and 31b and the pair of second frames 31c and 31d. The second frame 31c side of the lock frame 31 is provided with a power supply-side connection part 34 having a through hole and a power supply-side mounting screw 35 inserted through the through hole by the engagement of a head part with the power supply-side connection part 34. The second frame 31d side of the lock frame 31 is provided with a load-side connection part 36 having a through hole and a load-side mounting screw 37 inserted through the through hole by the engagement of a head part with the load-side connection part 36.

As illustrated in FIG. 7B, a locking plate 38 is continuously raised from an edge part on the opening part 31e side on the first frame 31a, which is one of the pair of first frames 31a and 31b, of the lock frame 31. In the locking plate 38, a first lock hole 39 is formed, and a first slotted hole 40 is formed along the direction in which the first frame 31a extends.

As illustrated in FIG. 7A, the handle catch 32 is a member including a rectangular slide part 41 and a catch part 42 formed by bending a metal flat plate into an L-shape to be orthogonal to each other. In the slide part 41, a second lock hole (or second lock opening region) 43 is formed which has the same hole shape as that of the first lock hole 19 of the locking plate 18 and a second slotted hole (or second slotted opening region) 44 is formed which extends in the longitudinal direction of the slide part 41 continuously from a part of the second lock hole 43, thereby forming a single opening. In the catch part 42, an engagement part 42a surrounding the periphery of the knob part 8 is formed.

A first slide pin 45 is inserted through the first slotted hole 40 from the locking plate 38 side. A head part of the first slide pin 45 is engaged with the opening peripheral edge of the first slotted hole 40, and a tip part of the first slide pin 45 penetrates the slide part 41 and is crimped and fixed to the slide part 41. A second slide pin 46 is inserted through the second slotted hole 44 from the slide part 41 side. A head part of the second slide pin 46 is engaged with the opening peripheral edge of the second slotted hole 44, and a tip part of the second slide pin 46 penetrates the locking plate 38 and is crimped and fixed to the locking plate 38.

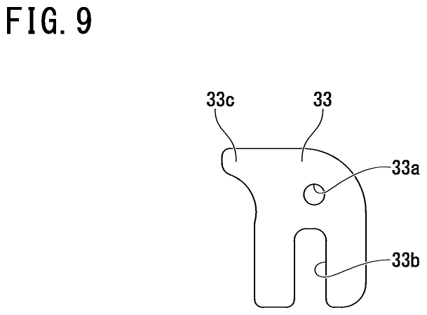

A member illustrated by the dashed line in FIG. 8 is a lock plate 33 arranged between the locking plate 38 and the slide part 41. As illustrated in FIG. 9, the lock plate 33 includes a shaft hole 33a, a slit 33b formed on a straight line passing through the center of the shaft hole 33a, and an engagement projection part 33c projecting outward. A shaft part according to the present invention corresponds to the shaft hole 33a.

As illustrated in FIG. 8, the lock plate 33 is arranged between the locking plate 38 and the slide part 41 such that the second slide pin 46 is inserted through the shaft hole 33a, the first slide pin 45 is inserted through the slit 33b, and the engagement projection part 33c projects toward the second lock hole 43. When the slide part 41 moves to the right side from the position in FIG. 8, the first slide pin 45 also moves to the right side in the longitudinal direction of the first slotted hole 40. When the first slide pin 45 moving to the right side comes into contact with the slit 33b of the lock plate 33, the lock plate 33 pivotaly rotates counterclockwise with the second slide pin 46 as the center of the rotation.

The second slide pin 46 may be integrally provided in a portion of the shaft hole 33a of the lock plate 33.

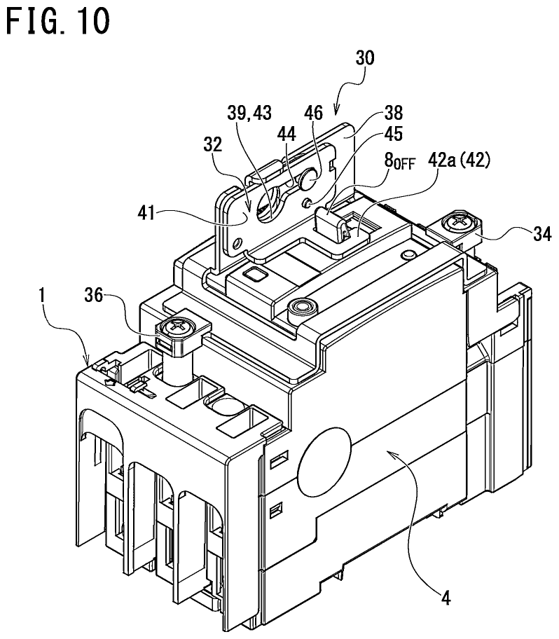

The handle lock device 30 having the above-described configuration is mounted to the circuit breaker 1 by inserting the knob part 8 into the engagement part 42a of the catch part 42, screwing the power supply-side mounting screw 35 of the power supply-side connection part 34 into the power supply-side engagement part of the circuit breaker 1 arranged in a board of a panel board, and screwing the load-side mounting screw 37 of the load-side connection part 36 into the load-side engagement part of the circuit breaker 1 as illustrated in FIG. 10.

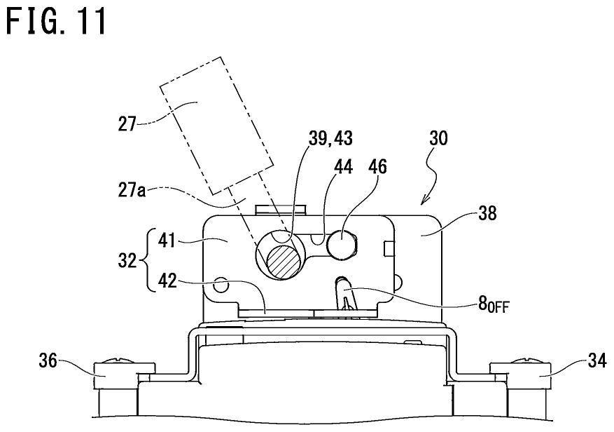

FIGS. 10 and 11 illustrate the arrangement of the handle lock device 30 when the knob part 8 of the circuit breaker 1 is set to the OFF position 8_{OFF}. As illustrated in the figures, the knob part 8 at the OFF position 8_{OFF} is engaged with the engagement part 42a, and the knob part 8 at the OFF position 8_{OFF} and the catch part 42 of the handle catch 32 are located on the left side in FIG. 11 at the OFF position. At this time, the first lock hole 39 of the locking plate 38 and the second lock hole 43 of the slide part 41 in communication with each other, allowing the hooking of the padlock 27 by the insertion of the shackle 27a through the first lock hole 39 and the second lock hole 43.

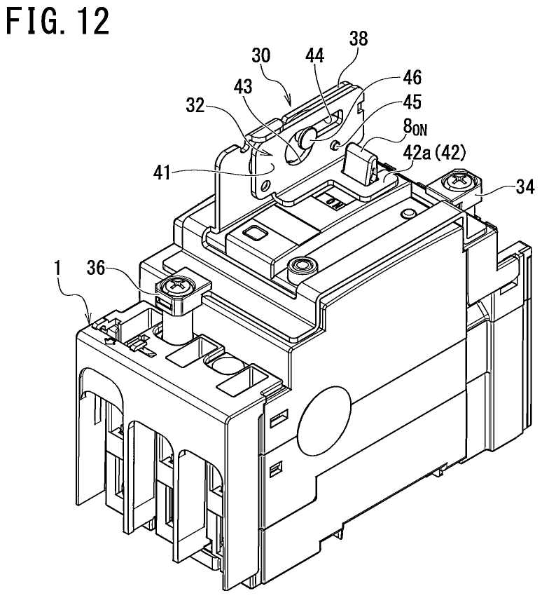

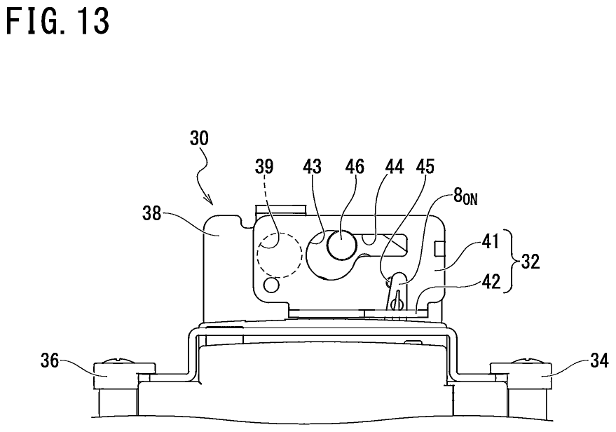

FIGS. 12 and 13 illustrate the arrangement of the handle lock device 2 when the knob part 8 of the circuit breaker 1 is set to the ON position 8_{ON}. Due to the ON position 8_{ON} of the knob part 8, when the catch part 42 of the handle catch 32 moves to the right side in FIG. 13, the first lock hole 39 of the locking plate 38 and the second lock hole 43 of the slide part 41 do not communicate with each other, not allowing the locking of the padlock.

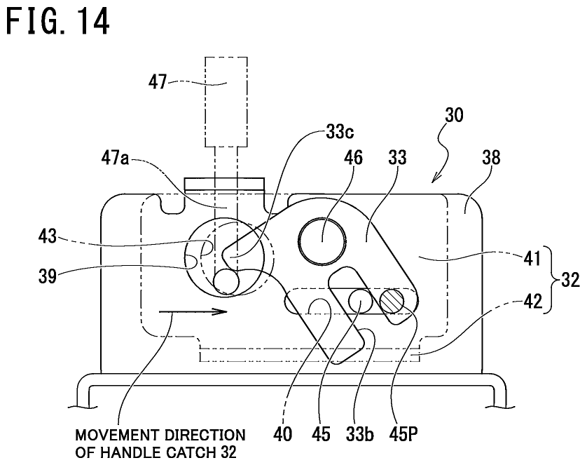

Next, FIG. 14 illustrates a case where the handle lock device 30 of this embodiment locks the circuit breaker 1 using a small padlock 47 having a small-diameter shackle 47a in place of the shackle 27 in which the diameter of the shackle 27a is large illustrated in FIG. 11. When a worker or the like moves the knob part 8 at the OFF position 8_{OFF} (see FIG. 11) to the ON position 8_{ON} side (right side in FIG. 14), the handle catch 32 moves to the right side in FIG. 14 until the hole peripheral edge of the second lock hole 43 of the slide part 41 is engaged with the shackle 47a, and the first slide pin 45 connected to the handle catch 32 also moves to the right side of the first slotted hole 40. Herein, when the handle catch 32 further moves to the right side and the first slide pin 45 also moves to the position designated by the reference numeral 45P (knob part switching position), there is a risk that the knob part 8 at the OFF position 8_{OFF} is switched to the ON position 8_{ON} by the operation of the toggle link mechanism.

In the handle lock device 30 of this embodiment, when the knob part 8 moves from the OFF position 8_{OFF} to the ON position 8_{ON} side (right side in FIG. 14), the first slide pin 45 moving to the right side of the first slotted hole 40 abuts on the slit 33b of the lock plate 33, so that the lock plate 33 rotates counterclockwise with the second slide pin 46 as the center of the rotation. In the lock plate 33 rotating counterclockwise, the engagement projection part 33c contacts a part of the shackle 47a of the padlock 47. Even when a further movement of the knob part 8 to the ON position 8_{ON} side is intended, the counterclockwise rotation of the lock plate 33 is restricted, and the first slide pin 45 is restricted from moving to the knob part switching position 45P. This restricts the movement of the catch part 42 of the handle catch 32 to the position where the position of the knob part 8 is switched to the ON position 8_{ON}.

Therefore, the handle lock device 30 of this embodiment can enhance the work safety because, even in a case where the locking is performed using the small padlock 47 having the small-diameter shackle 47a, the lock plate 33 restricts the movement of the knob part 8 to the position where the position is switched to the ON position 8_{ON} even when the knob part 8 is moved from the OFF position 8_{OFF} to the ON position 8_{ON} side.

The handle lock device 30 of this embodiment can enhance the work safety because the first lock hole 39 of the locking plate 38 and the second lock hole 43 of the slide part 41 communicate with each other only when the knob part 8 of the circuit breaker 1 moves to the OFF position 8_{OFF} as with the first embodiment, allowing the hooking of the shackle 27a of the padlock 27 (or the shackle 47a of the padlock 47) for locking.

Although FIG. 11 of the second embodiment illustrates the embodiment in which the shackle 27a of the padlock 27 is hooked through the first lock hole 39 of the locking plate 38 and the second lock hole 43 of the slide part 41 communicating with each other for locking, the same effects can be exhibited even when a hasp is hooked through the first lock hole 39 and the second lock hole 43 communicating with each other for locking.

Further, although FIG. 14 of the second embodiment describes a case where the handle lock device 30 locks the circuit breaker 1 using the small padlock 47 having the small-diameter shackle 47a, the lock plate 33 restricts the movement of the knob part 8 to the position where the position is switched to the ON position 8_{ON} also when the locking is performed by hooking a small hasp through the first lock hole 39 and the second lock hole 43 communicating with each other, making it possible to enhance the work safety.

### REFERENCE SIGNS LIST

1 circuit breaker
2 handle lock device
4 main body case
4a base
4b cover (case)
4c opening part
5 power supply-side terminal part
6 load-side terminal part
7a, 7b screw hole
8 knob part
8_{OFF} knob part OFF position
8_{ON} knob part ON position
10 lock frame
10a, 10b first frame
10c, 10d second frame
10e opening part
11 handle catch
12 lock plate
13 power supply-side connection part
14 power supply-side mounting screw
15 load-side connection part
16 load-side mounting screw
18 locking plate
19 first lock hole
20 first slotted hole
21 slide part
22 catch part
23 second lock hole
24a hole part
24b engagement projection
25 second slotted hole
26a, 26b slide pin
30 handle lock device
31 lock frame
31a, 31b first frame
31c, 31d second frame
31e opening part
32 handle catch
33 lock plate
33a shaft hole (shaft part)
33b slit
33c engagement projection part
34 power supply-side connection part
35 power supply-side mounting screw
36 load-side connection part
37 load-side mounting screw
38 locking plate
39 first lock hole
40 first slotted hole
41 slide part
42 catch part
42a engagement part
43 second lock hole (second lock opening region)
44 second slotted hole (second slotted opening region)
45 first slide pin
45P knob part switching position
46 second slide pin
47 small padlock
47a small-diameter shackle

1. A handle lock device for locking a knob part of a locker-type opening and closing operation handle projecting from a surface of the circuit breaker at an OFF position, comprising:
a lock frame having an opening part and configured to be mounted to the surface of the circuit breaker, the lock frame having a locking plate raised from an edge part forming the opening part, the locking plate having a first lock hole for receiving a shackle of a locking member and a first slotted hole;
a handle catch configured to include a catch part for holding the knob part and a slide part arranged to face the locking plate, the slide part having a second lock hole corresponding to the first lock hole;
a lock plate arranged between the locking plate and the slide part, the lock plate having a second slotted hole arranged to correspond to the first slotted hole, the second slotted hole having a longitudinal dimension shorter than that of the first slotted hole and a short-length dimension same as that of first slotted hole; and
a slide pin configured to be inserted through the first slotted hole of the locking plate and the second slotted hole of the lock plate and to slidably connect the slide part relative to the locking plate, wherein
the second lock hole of the slide portion is, at the OFF position of the knob part, in communication with the first lock hole of the locking plate, whereas the second lock hole of the slide portion is, at an ON position of the knob part, blocked with a part of the locking plate, and
the lock plate moves while blocking at least a part of the first slotted hole in a manner that the slide pin comes into contact with the second slotted hole in accordance with sliding motion of the slide part.

2. A circuit breaker handle lock device for locking a knob part of a locker-type opening and closing operation handle projecting from a surface of the circuit breaker at an OFF position, comprising:
a lock frame having an opening part and configured to be mounted to the surface of the circuit breaker, the lock frame having a locking plate raised from an edge part forming the opening part, the locking plate having a first lock hole for receiving a shackle of a locking member and a first slotted hole formed along a movement direction of the knob part;
a handle catch configured to include a catch part for holding the knob part and a slide part arranged to face the locking plate, the slide part having an opening forming a second lock opening region corresponding to the first lock hole and a second slotted opening region in continuously communication with the second lock opening region; and
a lock plate having a shaft part and arranged between the locking plate and the slide part and to be pivotably rotated around the shaft part;
a first slide pin configured to be inserted through the first slotted hole of the locking plate and the shaft part of the lock plate and to slidably connect the slide part with respect to the locking plate; and
a second slide pin configured to be inserted through the opening of the slide part and the shaft part of the lock plate and to be slidably connect the slide part relative to the locking plate, wherein
the second slotted hole of the slide part is, at the OFF position of the knob part, in communication with the first lock hole of the locking plate, and the second lock hole of the slide part is, at an ON position of the knob part, blocked with a part of the locking plate, and
the lock plate rotates around the shaft part so as to block at least part of the first lock hole in a manner that the first pin comes into contact with a part of the lock plate in accordance with sliding motion of the slide part by movement of the knob part from the OFF position to the ON position.
